(19) United States
(12) Patent Application Publication
(10) Pub. No.: US 2004/0042611 A1
(43) Pub. Date: Mar. 4, 2004

(54) Method and apparatus for inquiry resolution in a transaction processing system

(76) Inventors: Mark J. Power, Carol Stream, IL (US); Anthony J. Dezonno, Bloomingdale, IL (US); Roger A. Sumner, Batavia, IL (US); Carlo Bonifazi, Woodridge, IL (US); Jeffrey D. Hodson, Wheaton, IL (US); Craig R. Shambaugh, Wheaton, IL (US); Mark J. Michelson, Elburn, IL (US); Robert P. Beckstrom, Bolingbrook, IL (US)

Correspondence Address: Welsh & Katz, Ltd., Eric D. Cohen, 22nd Floor, 120 South Riverside Plaza, Chicago, IL, 60606, US

(21) Appl. No.: 10/228,980

(22) Filed: Aug. 27, 2002

(51) Int. Cl. H04M 3/00; H04M 5/00

(52) U.S. Cl. 379/265.02

(57) ABSTRACT

A method for resolving inquires in a transaction processing system is provided where the transaction processing system is configured to route incoming calls from callers to agents associated with the transaction processing system. The method includes a) receiving an incoming call by the agent, b) collecting inquiry parameters from the caller concerning an inquiry posed by the caller, c) providing the inquiry parameters to a knowledge-based database, d) selecting at least one entry in the knowledge database having inquiry parameters matching the inquiry parameters corresponding to the incoming call, e) obtaining inquiry solutions from each selected entry in the database; and f) providing one or more of the inquiry solutions to the agent wherein the agent presents one or more of the inquiry solutions to the caller to satisfy the caller's inquiry.

### FIELD OF THE INVENTION

The present invention relates generally to a method and apparatus for selectively routing calls to agents of a transaction processing system and/or an automatic call distribution system (“ACD”), and more specifically to a method and apparatus for presenting customer-based inquiries to a centralized knowledge base to determine an appropriate solution based on a priori solutions corresponding to other customers.

### BACKGROUND

Systems which automatically distribute customer contacts or calls (generically referred to as “ACD”) are often employed in telemarketing environments in which agents at agent stations answer many different types of calls including telephone calls and other types of customer contacts (e.g., VoIP, emails, facsimile, chat room dialog, instant messages, other Internet contacts, etc.) from customers during a work day. As referred to herein, an ACD may be referred to as an automatic call distributor or an automatic contact distributor because the ACD handles a variety of communication media. In other words, the ACD handles many forms of communication, not just telephone calls in which a potential customer speaks with an agent. The term “ACD” may apply to any type of transaction processing system, and need not apply only to dedicated telemarketing systems or automatic call distributors. In some known ACD's, the agent may receive certain information about the type of customer call (i.e. contact) on a visual display at the agent set when a call or contact is distributed to the agent. An ACD is any such system which performs these functions and, for example, may employ a wide variety of architectures including integrated centralized systems, distributed systems, systems using one or more personal computers or servers, etc.

In some embodiments, ACD's may be used to support a number of different vendors in their telemarketing effort, and in such marketing environments, the agent is typically in communication with the customer or potential customer with respect to or on behalf of a particular vendor. The next contact that the agent processes may be on behalf of the same vendor or on behalf of a different vendor. In another embodiment, ACD's may be used exclusively by or on behalf of a single vendor such that all of the contacts processed by the agent involve one particular vendor.

Often, a customer call is distributed to an agent that involves interactive voice dialog. This means a normal two-way verbal exchange. An ACD, however, may also distribute a non-voice dialog contact or call to the agent. This does not involve direct two-way speech between the agent and the customer or caller. Non-voice dialog communication may be, for example, emails, facsimile, chat room dialog, instant messaging, Internet, etc. and the like. This is becoming more common as Internet traffic and electronic sales transactions increase. Handling of the non-voice dialog contact may require a specialized device or subcomponent of the ACD. In this situation, the agent may typically view text on a display screen that the caller typed in or transmitted. In response, the agent may provide information to the contact or request information from the caller, via the keyboard or other input device. Essentially, the dialog between the agent and the caller occurs on a display screen. Further, the agent may handle multiple calls. For example, the agent may typically handle two to five (or more) simultaneous non-voice dialog communications or transactions, which may be presented as two to five separate dialog windows on the display screen, which windows may, for example, be tiled or layered. Of course, the number of simultaneous transactions may vary significantly.

To effectively service a customer, the agent must determine what the customer's need is. If the customer has a problem, the agent preferably provides a solution. In some instances, the agent is not familiar with the customer's problem or may be unequipped to understand the customer's problem and/or provide a solution. As such, the agent may forward the customer's call to another agent that he or she believes is better able to handle the incoming call. However, the agent to whom the incoming call is forwarded may not be the appropriate agent to handle the call either. This may result in the customer being “bounced” among a plurality of agents before the appropriate agent is selected. This results in customer dissatisfaction, which may negatively impact the business economies if widespread.

Even if the most appropriate agent is eventually selected, that agent may “reinvent the wheel” in attempting to resolve the problem. The same or similar problem may have been previously solved by different agent, who may or may not still be associated with the transaction processing system. However, there may be no record or no suitable way to retrieve the record corresponding to the previous solution. Accordingly, the agent would attempt the solve the customer's problem unaware that the solution has been previously found. This is very inefficient from both a time perspective and a cost perspective.

A need exists to permit the agent of a transaction processing system to locate and access stored information relating to the customer's problem or inquiry, which problem may have been previously addressed in an unrelated (or related) transaction, so that the agent may obtain a solution quickly, easily, and accurately.

### SUMMARY

The disadvantages of present transaction processing systems are substantially overcome by providing a novel method and apparatus for resolving a customer inquiry or customer problem presented to an agent of a transaction processing system. More specifically, a method for resolving inquires in a transaction processing system is provided where the transaction processing system is configured to route incoming calls from callers to agents associated with the transaction processing system. One embodiment of the method includes a) receiving an incoming call by the agent, b) collecting inquiry parameters from the caller concerning an inquiry posed by the caller, c) providing the inquiry parameters to a knowledge-based database, d) selecting at least one entry in the database having inquiry parameters matching the inquiry parameters corresponding to the incoming call, e) obtaining an inquiry solution from each selected entry in the database; and f) providing one or more of the inquiry solutions to the agent wherein the agent presents one or more of the inquiry solutions to the caller to satisfy the caller's inquiry.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a pictorial representation of a specific embodiment of a transaction processing system showing an exemplary inquiry resolution system;

FIG. 2 is a block diagram of a specific example of a known automatic call distribution system; and

FIG. 3 is a pictorial block diagram of a specific embodiment of an inquiry resolution system.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

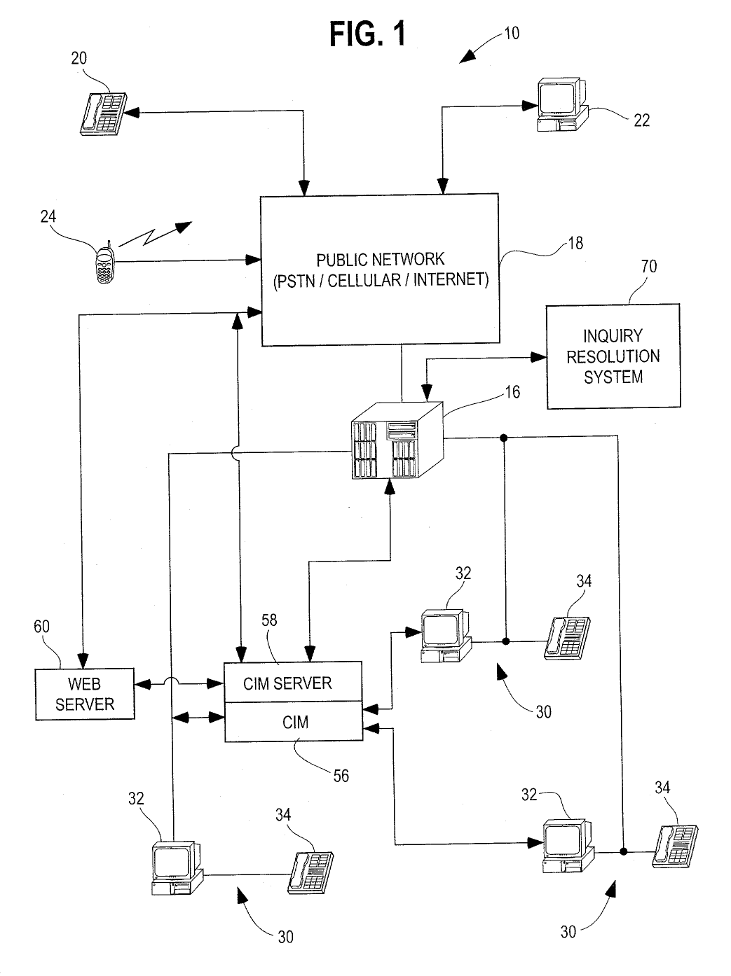

Referring now to FIG. 1, an exemplary embodiment of a system 10 for facilitating routing of incoming calls or contacts (“transactions”) to agents associated with a transaction processing system, which may also be referred to as an automatic call distribution or automatic contact distribution system (ACD) 16, is shown generally. The ACD 16 processes both voice-dialog communications or transactions, as well as non-voice dialog communications and transactions, as described hereinafter. The present invention may be implemented in numerous types and sizes of systems for distributing calls to selected ones of a plurality of agents. Examples of ACD systems that may be used in the present invention are the SPECTRUM ACD and Transcend ACD products available from Rockwell FirstPoint Contact.

Other types of call distribution systems including, for example, distribution systems or those using one or more personal computers or servers, may also be used. Some other suitable ACD's are disclosed in U.S. Pat. No. 5,268,903, issued to Jones et al. on Dec. 7, 1993, entitled “Multichannel Telephonic Switching Network With Different Signaling Formats and Connect/PBX Treatment Selectable For Each Channel,” U.S. Pat. No. 5,140,611, issued to Jones et al. on Aug. 18, 1992, entitled “Pulse width Modulated Self-Clocking and Self-Synchronizing Data Transmission and Method for a Telephonic Communication Switching System,” U.S. Pat. No. 5,127,004, issued to Lenihan et al. on Jun. 30, 1992, entitled “Tone and Announcement Message Code Generator for a Telephonic Switching System and Method,” U.S. Pat. No. 6,289,373 B1, issued to Dezonno on Sep. 11, 2001, entitled “Method of Processing E-Mail in an Automatic Call Distributor,” and U.S. Pat. No. 6,097,806, issued to Baker et al. on Aug. 1, 2000, entitled “ACD with Multi-Lingual Agent Position,” the disclosures of which are hereby incorporated by reference in their entirety.

A customer or caller may be connected to the ACD 16 through a public switched telephone network (PSTN) 18, which caller may connect to the PSTN through a standard telephone set 20, a computer 22, a cellular telephone 24, or any suitable communication device. Note that the term “caller” as used herein does not necessarily mean that the contact or person using the telephone 20, for example, initiated the call to the agent. Notably, the agent may have initiated the call to the contact. Accordingly, the term “caller” shall broadly refer to the contact or potential customer even though the agent may have originated or initiated the call or contact. Additionally, the term “call” may be a telephone call, or it may be any other form of communication (emails etc.) as set forth above.

In the illustrated embodiment, multiple agent stations or terminals 30 are shown coupled to the ACD 16. For purposes of illustration, only three agent stations are shown, but any suitable number of agents may be coupled to the ACD 16. The agent stations 30 may also include agent station computers 32 or terminals, and/or telephone sets 34.

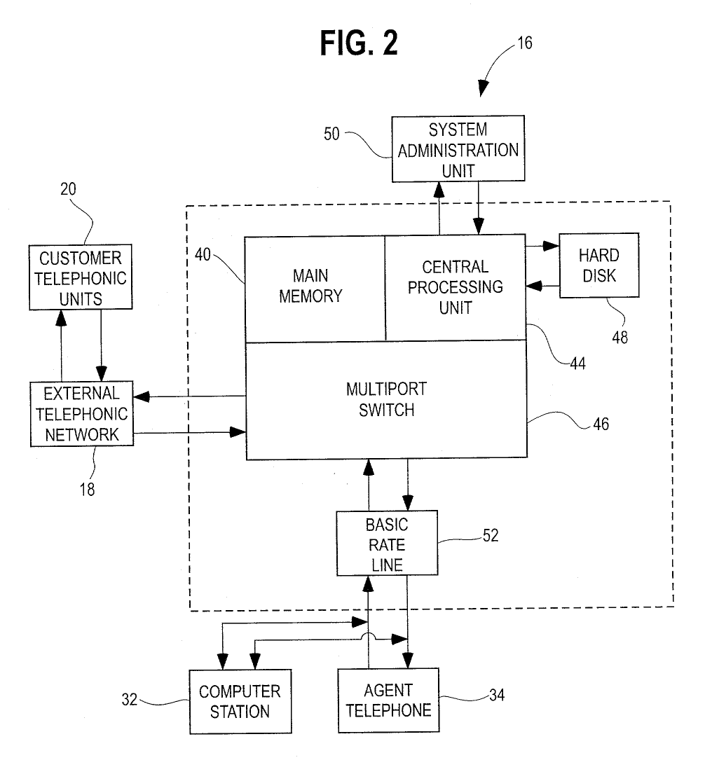

Referring now to FIGS. 1 and 2, FIG. 2 shows an example of an ACD 16 in greater detail. The ACD 16 may comprise hardware and/or software and, for example, may include a main memory 40, a central processing unit 44 and a multiport switch 46, each of which may be separate units, distributed components, or integrated at a single location or single cabinet. The multiport switch 46 is coupled to the PSTN 18, which in turn, is connected to customer telephones 20 or other communication devices (20, 22, or 24). The central processing unit 44 may include storage, such as hard disk storage 48, and may also be coupled to a system administration unit 50. The ACD 16 is connected through a suitable communication link to the plurality of agent telephonic sets 34, for example, through a basic rate line 52, as is known in the art. The agent computer station 32 and the agent telephone sets 34 may be incorporated into a single unit, as is known in the art.

The illustrated ACD 16 may handle voice communication and may also handle non-voice communication, such as emails, facsimile, chat room dialog, instant messaging, Internet, etc. Non-voice dialog communication is another form of contact communication and the ACD 16, when configured and coupled to appropriate hardware and/or software devices, as described below, is not limited to processing voice-based telephone calls. The ACD 16 may be a single integrated device, or may include distributed hardware and software. In one specific embodiment, the SPECTRUM ACD product available from Rockwell FirstPoint Contact may include a non-voice dialog communication processor, such as a Contact Integration Manager (CIM) 56, which may, for example, be a CIM Release No. 1.1, which is also available from Rockwell FirstPoint Contact. In the specific embodiment shown, the communication processor 56 or CIM (also referred to as non-voice dialog communication processor or communication processor) may handle the non-voice dialog communication between the customer or caller, and the agent.

The communication processor 56 may be operatively coupled to the ACD 16 and to the agent computer 32 or agent stations 30. In the illustrated embodiment of FIG. 1, the communication processor 56 typically receives email, chat room dialog, facsimile, instant message, Internet communication, and the like from a communication processor server 58. The communication processor server 58, in turn, may receive additional non-voice dialog contact communication from a web server 60, which may be connected to the PSTN 18 or some other communication network, as is known in the art. In one specific embodiment, the communication processor 56 may be separate from the ACD 16 and operatively coupled to the ACD 16. Alternatively, the communication processor 56 may be integrated into a portion of the ACD 16 or any other processor or processors in the system. In another embodiment, at least a portion of the communication processor 56 functionality may be part of the agent station computer 32, which may be, for example, a personal computer. The communication processor 56 may be any suitable computing device, such as, for example a microprocessor, RISC processor, mainframe computer, work station, single-chip computer, distributed processor, server, controller, micro-controller, discrete logic computer, remote computer, personal computer, internet computer, web computer, and the like.

With respect to the apparatus and method described herein, the term ACD 16 is used interchangeably to mean either the ACD and/or the communication processor 56, or a combination of both. Both terms relate to a “transaction processing system” and because the ACD 16 and the communication processor 56 may be so closely related or the functions so distributed that a meaningful distinction may not be able to be made with respect to which particular component is performing a specific step described. Accordingly, for purposes of illustration only, the below-described method will be described in terms of the ACD 16 performing the step or the communication processor 56 performing the step, even though a separate component or subcomponent, such as the other of above-mentioned components, may perform the step or process.

The communication processor 56 in the illustrated embodiment is configured to facilitate sending and receiving non-voice dialog communication between the caller and the agent or agent terminal 30, and to transmit a signal to the ACD 16 indicating that the communication processor received the non-voice dialog communication from the caller. The signal from the communication processor 56 to the ACD 16 creates a “call appearance” so that the ACD is brought into the communication “loop,” and is able to track the contact. In one embodiment, the call appearance simulates to the ACD 16 the appearance of a voice-type call, even though a voice-type call is not present. Once the call appearance to the ACD 16 has been made, the ACD can queue and track the non-voice dialog communication to the appropriate agent as if the call were an ordinary interactive voice-dialog call, even though the ACD may not utilize or connect its voice channel to the agent. For example, the communication processor 56 may handle the non-voice dialog communication and provide the call to the agent, and also inform the ACD 16 regarding the status and initiation of the call

Accordingly, once the call appearance has been made, the ACD 16 in the illustrated embodiment of FIG. 1 selects a particular agent to receive the non-voice dialog communication from the communication processor 56, and then causes the non-voice dialog communication to be routed to the selected agent by the communication processor. In known automatic call distribution systems, selection of the agent is performed according to any suitable method including known methods, such as the agent's availability, time past since prior contact, number of calls previously processed by the agent, skill or efficiency rating of the agent, and the like.

In known ACD systems, when such a contact is routed to an agent, the system notifies the agent that a call has arrived, by means known in the art. For example, a message may appear on the agent station 30 and/or an audible signal may be sent to the agent. If the incoming call is a voice dialog communication, the agent speaks with the caller. If the incoming call is a text-based communication, the agent may communicate with the caller, for example, by reading and typing messages on the agent station 30 or agent computer.

The transaction processing system 16 of the illustrated embodiment of FIG. 1 preferably routes voice dialog communication to a selected agent station 30 for servicing by an associated agent using the agent telephone 34 or headset. In conjunction with the communication processor 56, the transaction processing system 16 may, for example route non-voice dialog or text-based communication to the selected agent station. Again, as set forth above, the communication processor 56 need not be separate or apart from the transaction processing system 16 and may be operatively incorporated into the transaction processing system. In operation, the transaction processing system 16 and/or the communication processor 56 routes incoming calls from the callers to the agents, where the incoming calls may be voice dialog communication or non-voice dialog communication, such as VoIP (voice-over Internet protocol), email, facsimile, chat room dialog, instant messages, and other Internet contacts.

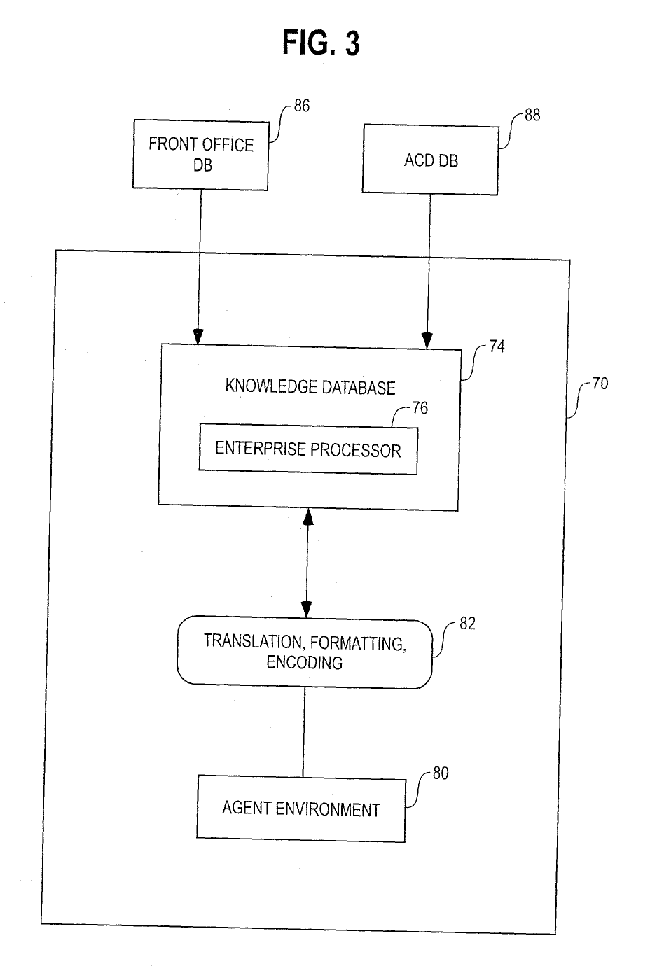

Referring now to FIGS. 1-3, an inquiry resolution system 70 is shown operatively coupled to the transaction processing system 10 of FIG. 1, which inquiry resolution system is shown in greater detail in FIG. 3. Note that the inquiry resolution system 70 is preferably coupled to the ACD 16, but alternatively may be part of the communication processor 56. Further, the inquiry resolution system 70 may be separate and apart from any of the above-mentioned components. It is immaterial to the scope of this invention where the inquiry resolution 70 is physically located. Further, the inquiry resolution system 70 may be in the form of hardware or processing devices, or may be implemented in software, which may, for example, execute on the ACD 16 or other hardware in the system.

As described above, an incoming call may be routed to an agent who may not be familiar with the caller's problem or inquiry, and may not be knowledgeable about the particular subject matter of the call. Some transaction processing systems merely route an incoming call to an agent who is not busy or who has not serviced a transaction for a predetermined period of time. This is inefficient, especially if the agent is not familiar with the subject matter of the caller's inquiry.

As mentioned above, the agent may attempt to transfer to the call to another agent, but such “bouncing” of the caller to many different agents leads to customer dissatisfaction and potential loss of business. However, the agent's efficiency may be greatly improved if that agent could quickly access information about the subject matter of the caller's inquiry or problem sufficient to permit that agent to provide an appropriate solution to the caller even though that agent may not have first-hand knowledge regarding the subject matter of the caller's inquiry.

Accordingly, the inquiry resolution system 70 may include a knowledge database 74, which is preferably operatively coupled to an enterprise processor 76. The knowledge database 74 may contain certain information that the agent seeks in response to the incoming call. Note that the enterprise processor 76, in some specific embodiments, may not exist, and its function may be subsumed or incorporated into the ACD 16, the communication processor 56 or other processing component of the transaction processing system 10. If the processor 44 (FIG. 2) of the ACD 16 is sufficiently powerful, it can access and process the data in the knowledge database 74.

As shown in the embodiment of FIG. 3, the enterprise processor 76 and knowledge database 74 may be coupled to an “agent environment” 80. This means that the agents associated with the ACD 16 may also communicate with the inquiry resolution system 70 by transmitting requests to the inquiry resolution system and receiving responses therefrom.

A brief summary of the operation of an exemplary embodiment of an inquiry resolution system 70 follows. An incoming call or contact is routed to an agent, and a dialog between the agent and the caller is initiated. Based on the dialog, the agent collects and enters key words and/or key phrases (also referred to as “inquiry parameters”) that he or she deem are relevant to the caller's inquiry. To more rapidly provide an answer to the caller's inquiry or to provide a solution to the caller's problem, the agent may provide the inquiry parameters to the inquiry resolution system 70.

Based on the inquiry parameters provided, a database search may then be performed to find database entries having inquiry parameters that match the inquiry parameters corresponding to the incoming call. The database entries may be, for example, existing or historical records containing data concerning prior transactions, including a description of past customer problems, complaints, and the like, and corresponding solutions. The matching database entries may contain inquiry solutions or solutions to problems that are the same or similar to the customer problem or inquiry with which the agent is presently involved.

The matching inquiry solutions, and corresponding inquiry parameters may then be presented back to the agent for consideration. In reviewing the inquiry solutions, the agent may select one or more of the inquiry solutions that the agent believes is most relevant to the customer issue at hand. The agent may then present one or more of the inquiry solutions to the customer, which may provide a solution to the caller's needs. Accordingly, rather than “bouncing” the caller to a plurality of agents and frustrating the caller, it is possible for an agent to provide the caller with a solution even though the agent may not personally know the answer.

Of course, the integrity and efficacy of the search may be somewhat dependent upon the skill, experience, and intelligence of the agent who selects the key words. This is analogous to using an Internet search engine, such as Google.com or Alta-Vista.com, where key words are entered into the search engine to produce a “hit list” of results. Similarly, if the key words entered by the agent do not accurately reflect the substance of the caller's inquiry or the available information in the database 74, the results of the search may be poor.

As described above briefly, in one embodiment, when an incoming call or contact is routed to an agent, a dialog between the agent and the caller is initiated. The dialog may be voice dialog or text-based dialog. Such text-based dialog may include, for example, email, chat-room sessions, instant messages, facsimile, other text messages, and the like. Based on the dialog between the agent and the caller, the agent soon understands the subject matter of the caller's inquiry or problem. The agent may or may not have a solution at hand. In either case, during the course of the dialog, the agent preferably collects the inquiry parameters that quantify or “define” the caller's inquiry or problem.

In one specific embodiment, the inquiry parameters are established by the agent by defining or generating key words or key phrases based upon the dialog between the agent and the caller. This is somewhat subjective and is based on the agent's past experience and knowledge. For example, a call may be routed to an agent of an ACD system 16, where the ACD system corresponds to a business that sells electronic and computer components. The caller may have purchased, for example, a Seagate Barracuda IV 7200 RPM 40 Gbyte hard disk drive and found that the product does not function properly. The agent preferably ascertains this information early during the dialog with the customer. The agent may be further advised that the disk drive emits a “grinding” sound, that the disk drive is recognized by the personal computer, but that no data can be read from or written to the disk drive.

Accordingly, the agent may enter the following key words or inquiry parameters in a display screen associated with the incoming call as follows: “disk drive,” “Seagate,” “Barracuda IV,” “grinding sound,” “read failure, “write failure,” “platform is IBM PC.” If the dialog between the agent and the caller is text-based, the same key words may be “cut and pasted” from the agent's screen to an appropriate dialog box associated with the incoming call. In one specific embodiment, entry of the key words may be facilitated by an inquiry parameter formatter 82 that assists the agent in entering and organizing the key words or phrases. The inquiry parameter formatter 82 may be based on a commercially available word processor or may alternately utilize text functions of the operating system, such as the Microsoft WINDOWS operating system, used in conjunction with the ADC 16, communication processor, or resolution inquiry system 70.

Alternatively, a variety of data or key word “forms” or “templates” may be available to the agent to obviate the need to type in the data. Such key word forms or templates may be integrated into the inquiry parameter formatter 82. In such an embodiment, the agent may enter a single key word, such as “disk drive” and a list of possible key words may be presented to the agent with a large choice of possible options or “sub” key words. Layers of key words logically organized in a hierarchical manner may be provided. The agent need only “click on” the key words in the list that the agent deems relevant to the caller's inquiry or problem. Many possible key words may be presented to the agent, including but not limited to key words relating to product name, product number, product identification, product make, product model, customer name, customer number, product part failure identification, failure symptoms, anomalies, and the like. Of course, this exemplary list illustrates only a very small number of possible key words.

The key words collected by the agent may then be transmitted to the resolution inquiry system 70. The enterprise processor (whether it is incorporated into or separate and apart from the ACD 16, communication processor 56, agent terminals, and the like) may then further format and/or encode the key words in preparation for a database search. In one embodiment, the inquiry parameters are processed or formatted by the enterprise processor 76. Alternatively, the inquiry parameters are may be used in the form entered by the agent.

In another specific embodiment, the key words are formatted, translated, or encoded into an XML-based (extensible mark-up language) resource language. Of course, any suitable resource language or database language may be used, as is known in the art. Use of an XML-based resource language may increase the flexibility and portability of the system, and may permit use of economical and commercially available software modules.

Once such commercially available software module may be a “spelling checker,” which may be invoked to correct inadvertent spelling errors. Such misspellings may negatively impact a database search based on key words. For example, if the agent enters the inquiry parameter “reat failure” instead of “read failure,” a database search may not find a match. Additionally, a grammar-checker or thesaurus-type of program may be used to increase the scope of the database search. For example, if the key word entered by the agent is “read failure,” the grammar-checker or thesaurus-type of program may allow for or search for a range of corresponding or equivalent entries, such as “will not read” “won't read” “read function broken” and the like. Preferably, such a thesaurus-type of program permits use of equivalents relating to pluralization, phonetic equivalents, homonyms, similar meanings, embedded words, “wildcards” and the like. Any suitable commercially available program mentioned above may be used, such as Spell Checker 3.02 available from Michael Quinion Associates, AutoSpell available from Compubridge, Inc., Word 97 Grammar Checker available from Microsoft Corporation, and the like.

The implementation of the above-described procedure may be somewhat variable without departing from the scope of the invention. For example, the agent may precisely define and enter the input parameters, or may loosely define the input parameters. In the latter situation, the enterprise processor 76 may encode or translate the loosely defined input parameters into a stricter or a more accurate subset of input parameters.

With respect to the database 74, one such suitable knowledge database may be made using Oracle 11i Relational Database software available from Oracle Corporation, but any suitable database may be used. Preferably, the database is a relational database rather than a flat-file database.

Once the inquiry parameters have been collected and entered, the inquiry parameters are transmitted to the inquiry resolution system 70. The database 74 is then searched to locate records that match the inquiry parameters. The records in the database 74 also contain inquiry parameters or key words associated with prior transactions or customer inquiries. Moreover, such records may also include the prior solution that was presented to the customer in response to his or her inquiry. Accordingly, the database 74 is searched to locate all records whose inquiry parameters match the inquiry parameters of the agent's subject transaction.

Note that the database 74 may be indexed by any suitable method, as is known in the art. For example, the database 74 may be indexed by customer number or customer identification, inquiry parameters, problem type, and the like. Because the database 74 is preferably a relational database, the indexing method used can be quickly and easily specified or changed. As discussed above, regardless of the indexing scheme, the database 74 is also preferably searched based on equivalent key words or inquiry parameters (plural, singular, phonetic equivalent, and the like), not just “exact” key words.

Of course, if the database entries include a large number of inquiry parameters or key words, and if the agent's inquiry parameters or key words collected are also numerous, it is likely that the number of matching database entries may be relatively large. Accordingly, the matching entries may be grouped in ascending order from the bottom to the top based upon the number of inquiry parameters or key words in common, which is intended to organize the matching database entries in order of importance.

For example, the database entry having the greatest number of inquiry parameters or key words in common with the agent's inquiry parameters or key words may be presented as the first entry in a list. Depending upon the number of matching database entries found, a limited number of matching entries, for example, ten entries, may be presented to the user. Of course, this number is variable and may be set to any suitable number. One objective is to provide the agent with the information from a suitable number of matching database entries, which is preferably limited to a useful number so that the agent can quickly and efficiently obtain a solution to the customer's inquiry or problem.

Once the matching database entries have been located and limited, if necessary, the corresponding inquiry solution in each ordered database entry is provided back to the agent in response to his or her request. The presentation of the inquiry solutions may be in any suitable format, such as a formatted output, or it may be in the form of “written prose” or “free-flowing thoughts,” which reflect the words of the prior agent who may have solved the customer's problem corresponding to that particular matching database entry.

After the agent has received the inquiry solutions from the inquiry resolution system 70, the agent must review the inquiry solutions and apply some degree of thought. The agent may pursue additional dialog with the caller to further narrow the scope of the solution. Alternately, the agent may suggest one or more of the inquiry solutions to the caller so that the caller may attempt to implement the solution. Of course, the caller may attempt to implement the suggested solution immediately, that is, while having on-going dialog with the agent, or the caller may terminate the dialog with the agent and attempt to implement the suggested solution at a later time.

For example, the key words or inquiry parameters given in the previous example, namely, “disk drive,” “Seagate,” “Barracuda IV,” “grinding sound,” “read failure, “write failure,” “platform is IBM PC,” may have matched some of the key words or inquiry parameters in a selected database entry. Perhaps the matching database entry contained three key words in common with the agent's inquiry parameters, namely, “Seagate,” “Barracuda IV,” “grinding sound.” Further, in this specific example, the inquiry solution in the database entry may reflect the prior agent's comments or solution as follows: “check ribbon cable B to make sure that pin 38 is not shorted to pin 39, this will fix the grinding sound problem.” Accordingly, the agent may suggest this solution to the caller.

Preferably, the agent will be apprised of the result of the caller's implementation of the suggested inquiry solution, either during the dialog between the agent and the customer, or during a later follow-up dialog. In either of the above-described situations, once the agent as been apprised of the results of suggested inquiry solution, if the suggested inquiry solution turns out to be the correct solution (a “validated solution”), that inquiry solution is stored in the database along with the inquiry parameters corresponding to the agent's present transaction. In this way, the knowledge base of the database 74 is continuously built up, expanded and improved.

In one specific embodiment, the dialog between the agent and the caller may be identified or indexed by a caller number or caller identification. The inquiry parameters or key words collected by the agent may then be associated with such a caller identification. Additionally, the suggested inquiry solutions are also associated with the caller identification. Once the agent has received confirmation that the suggested inquiry solution is correct, a record containing the inquiry parameters collected by the agent and the correct or “verified” inquiry solution may stored in the database 74, along with the identity of agent handling the call.

Further, if the agent receives additional information at a later time regarding the inquiry solution or receives corrected information, the agent may update the previously stored database 74 record with the new information. This assists in “fine-tuning” the solution and improves the accuracy of the suggested inquiry solutions. Note that the inquiry parameters associated with the incoming call are preferably not stored in the database 74 until the agent receives some form of confirmation or verification that the inquiry solution was correct and that it solved the customer's problem.

However, if no solution could be found, the inquiry parameters collected by the agent during the transaction may be nonetheless stored in the database 74 with a corresponding inquiry solution entry indicating that no solution could be found. This may also be beneficial to an agent who encounters the same problem or inquiry at a later time because that agent may be immediately informed that the same or similar caller problem or inquiry had been previously addressed, and that no solution has ever been found.

To assist the agent in servicing a transaction, additional information may be available to the knowledge database 74. This may be in the form of “Front Office” access or an additional database (“front office database) 86 available to either the agent or the resolution inquiry system 70. The knowledge database 74 may be operatively coupled to the front office database 86 by means known in the art. Alternately, the front office database 86 may be part of the knowledge database 74.

For example, additional business information may be helpful in handling a transaction, such as information relating to inventory, sales volume, shipping & receiving, manufacturing, product information, accounting data, and the like. For example, in the above-described situation where an agent was not able to find an inquiry solution, the agent may access the front office database 86 to determine the number of such products sold or shipped. Perhaps all of such products sold contained the same defect, and in this situation, other agents may be alerted to expect similar incoming calls dealing with the product defect. Additionally, as proactive move, the customers who purchased this product may be notified of the defect, or the product may be recalled.

Additionally, the front office database may include ACD agent data or may be connected to an ACD database 88. The information contained in the ACD database 88 may relate to the status of the agents, such as if they are logged into their station, generally available, on vacation, at lunch, and the like.

In another specific alternate embodiment, the agent may review the proposed inquiry solutions provided by the inquiry resolution system 70 and may determine that, notwithstanding the inquiry solutions provided by the inquiry resolution system, he or she may not be the appropriate agent to handle the call. Accordingly, the agent would prefer to transfer the incoming call to a more suitable agent. Although not ideal, a single transfer of the incoming call to another agent is acceptable in most situations.

To determine the most suitable agent to whom to transfer the incoming call, the agent may request that the inquiry resolution system 70 provide the agent with the identity of a “preferred agent.” Alternatively, the identity of the preferred agent may be provided to the agent along with the suggested inquiry solutions without the agent making a specific request to the inquiry resolution system 70. For example, the preferred agent may be selected based on the frequency of occurrence of a particular agent's name corresponding to the matching database entries provided by the inquiry resolution system 70. If the inquiry resolution system 70 provided the agent with ten possible inquiry solutions from ten different matching database entries, and if seven of those ten inquiry solutions were previously handled by one specific agent, then is it likely that that specific agent has greater experience than other agents in dealing with the problem at hand. Accordingly, the specific agent is deemed to be the preferred agent, and the incoming call may be transferred from the current agent to the preferred agent.

Of course, the preferred agent must be available to receive the incoming call. If the preferred agent is on vacation, an alternate preferred agent, if any, may be selected. To determine the availability of the agents, the inquiry resolution system 70 may access the ACD database 88 to determine availability.

In another specific alternate embodiment, the agent may issue a “help request” to a predetermined number of agents or to a selected group of agents. This may occur while the agent is engaged in an on-going dialog with the caller, or may occur after the transaction has been terminated. For example, if the agent cannot provide an adequate solution to the caller but believes that another agent or group of agents may know the solution, such other agents may be contacted. For example, one particular group of agents may be dedicated to handling a particular type of inquiry, such as computer products. Accordingly, the agent handling the incoming call relating to a “disk drive failure,” in the example set forth above, may issue the help request to that particular group of agents.

Preferably, the agent requesting help may forward the inquiry parameters collected for the current inquiry or transaction to the selected agent or group of agents, along with the suggested inquiry solutions, if any, provided by the inquiry resolution system 70. One or more of the agents receiving the help request may have experience or may have particular knowledge regarding the problem encountered by the agent requesting help. As such, that agent receiving the help request may be able to provide the needed information. If it is determined that the information provided the “helping agent” was a correct or verified solution, that information is then stored in the knowledge database 74, as described above.

Specific embodiments of an inquiry resolution system for a transaction processing system according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A method for resolving inquires in a transaction processing system, the transaction processing system configured to route incoming calls to agents associated with the transaction processing system, the method comprising the steps of:
a) routing an incoming call from call from a caller to an agent;
b) collecting inquiry parameters from the caller concerning an inquiry posed by the caller;
c) providing the inquiry parameters to a knowledge-based database;
d) selecting at least one entry in the database having inquiry parameters matching the inquiry parameters corresponding to the incoming call;
e) obtaining at least one inquiry solution from each selected entry in the database; and
f) providing one or more of the inquiry solutions to the agent.

2. The method according to claim 1 wherein the agent receiving the incoming call presents one or more of the inquiry solutions to the caller to satisfy the caller's inquiry so that the caller is not transferred to another agent.

3. The method according to claim 1 wherein the agent presents one or more of the inquiry solutions to the caller to satisfy the caller's inquiry.

4. The method according to claim 1 wherein the inquiry parameters are collected by the agent in the form of key words or key phrases based upon a dialog between the agent and the caller.

5. The method according to claim 4 wherein the dialog between the agent and the caller includes at least some text-based dialog.

6. The method according to claim 1 wherein the step of collecting the inquiry parameters includes the step of the selecting key words from a form or template based on a dialog between the caller and the agent.

7. The method according to claim 1 wherein the inquiry parameters are encoded to quantify the inquiry posed by the caller.

8. The method according to claim 4 wherein the key words are selected from the group consisting of product name, product number, product identification, product make, product model, customer name, customer number, and product part failure identification.

9. The method according to claim 1 wherein the inquiry parameters are formatted or translated using an XML-based language.

10. The method according to claim 1 wherein a knowledge-based processor operatively coupled to the database searches the database to find a match between the inquiry parameters corresponding to the incoming call and inquiry parameters of a plurality of database records.

11. The method according to claim 10 wherein the plurality of database records are indexed by a problem identification or problem type.

12. The method according to claim 10 further including that step of determining the number of key words in common between the inquiry parameters corresponding to the incoming call and the inquiry parameters of each of the plurality of database records.

13. The method according to claim 1 wherein the inquiry parameters corresponding to the incoming call are stored or indexed in the database and are associated with verified corresponding inquiry solutions.

14. The method according to claim 13 further including the step of storing the inquiry parameters corresponding to the incoming call and the verified corresponding inquiry solutions in the database to build a knowledge base of related inquiries and solutions.

15. The method according to claim 1 further including the step of determining an identity of a preferred agent most closely associated with the inquiry solutions corresponding to the selected entries in the database.

16. The method according to claim 15 wherein the preferred agent is an agent whose agent name or identification appears greater than a predetermined number of times in the plurality of obtained inquiry solutions, said incoming call being transferred from the agent to the preferred agent, wherein the preferred agent presents one or more of the inquiry solutions to the caller to satisfy the caller's inquiry.

17. The method according to claim 15 further including the step of issuing a request for additional information to the preferred agent to obtain additional solutions relating to the caller's inquiry.

18. The method according to claim 15 further including the step of issuing a request for additional information to a predetermined number of agents to obtain additional solutions relating to the caller's inquiry.

19. The method according to claim 1 wherein the knowledge-based processor is operatively coupled to a front-office database that contains entries selected from the group consisting of inventory entries, sales entries, shipping entries, manufacturing entries, product entries, stocking entries, accounting entries, agent availability, agent log-in status and agent employment schedule.

20. The method according to claim 1 wherein the inquiry solutions are provided to the agent in a hierarchal order based upon the number of key words in common between the inquiry parameters corresponding to the incoming call and the inquiry parameters of each of the plurality of database records.

21. An inquiry resolution system for resolving inquires in a transaction processing system, the transaction processing system configured to route incoming calls to agents associated with the transaction processing system, the inquiry resolution system comprising:
knowledge database;
a knowledge-based processor operatively coupled to the knowledge database;
an inquiry parameter formatter configured to format key words or phrases collected by the agent in the form of inquiry parameters during a dialog with a caller, the formatter providing the inquiry parameters to the processor; and
wherein the processor searches the database and selects at least one entry in the database having inquiry parameters matching the inquiry parameters corresponding to the dialog, and obtains an inquiry solution from each selected entry in the database.

22. The system according to claim 21 wherein the inquiry parameters are collected by the agent in the form of key words or key phrases based upon a dialog between the agent and the caller.

23. The system according to claim 21 wherein the inquiry solutions are provided to the agent for presentation to the caller.

24. The system according to claim 21 wherein the knowledge-based processor searches the database to find a match between the inquiry parameters corresponding to the incoming call and inquiry parameters of a plurality of database records.

25. The system according to claim 21 wherein the inquiry parameters corresponding to the incoming call are stored or indexed in the database and are associated with verified corresponding inquiry solutions.

26. The system according to claim 21 further wherein the knowledge-based processor determines an identity of a preferred agent most closely associated with the inquiry solutions corresponding to the selected entries in the database.

27. The system according to claim 21 wherein the knowledge-based processor is operatively coupled to a front-office database that contains entries selected from the group consisting of inventory entries, sales entries, shipping entries, manufacturing entries, product entries, stocking entries, accounting entries, agent availability, agent log-in status and agent employment schedule.

28. An inquiry resolution system for resolving inquires in a transaction processing system, the transaction processing system configured to route incoming calls from callers to agents associated with the transaction processing system, the inquiry resolution system comprising:
knowledge database;
processing means operatively coupled to the knowledge database;
means for formatting key words or phrases collected by the agent in the form of inquiry parameters during a dialog with the caller, the means for formatting providing the inquiry parameters to the processing means; and
wherein the processing means searches the database and selects at least one entry in the database having inquiry parameters matching the inquiry parameters corresponding to the dialog, obtains an inquiry solution from each selected entry in the database, and provides the inquiry solutions to the agent for presentation to the caller.

29. The system according to claim 28 wherein the inquiry parameters are collected by the agent in the form of key words or key phrases based upon a dialog between the agent and the caller.

30. The system according to claim 28 wherein processing means searches the database to find a match between the inquiry parameters corresponding to the incoming call and inquiry parameters of a plurality of database records.

31. The system according to claim 28 wherein the inquiry parameters corresponding to the incoming call are stored or indexed in the database and are associated with verified corresponding inquiry solutions.

32. The system according to claim 28 wherein the processing means determines an identity of a preferred agent most closely associated with the inquiry solutions corresponding to the selected entries in the database.

33. The system according to claim 28 wherein the processing means is operatively coupled to a front-office database that contains entries selected from the group consisting of inventory entries, sales entries, shipping entries, manufacturing entries, product entries, stocking entries, accounting entries, agent availability, agent log-in status and agent employment schedule.
